(19) United States
(12) Patent Application Publication
(10) Pub. No.: US 2011/0300514 A1
(43) Pub. Date: Dec. 8, 2011

(54) METHOD OF TACTICAL TRAINING USING A PORTABLE STRUCTURE AND A PORTABLE STRUCTURE

(76) Inventors: Steven J. Didier, Grangeville, ID (US); Anthony Lambraia, Grangeville, ID (US)

(21) Appl. No.: 13/045,994

(22) Filed: Mar. 11, 2011

Related U.S. Application Data
(60) Provisional application No. 61/350,993, filed on Jun. 3, 2010.

(51) Int. Cl. G09B 9/00

(52) U.S. Cl. 434/11

(57) ABSTRACT

Disclosed is a portable training structure and a method for tactical training using a portable structure.

### PRIORITY/CROSS-REFERENCE TO RELATED APPLICATIONS

This application claims the benefit of U.S. Provisional Application No. 61/350993, filed Jun. 3, 2010, the disclosure of which is incorporated by reference.

### TECHNICAL FIELD

The disclosure generally relates to the field of portable structures and strategic training methods. Particular embodiments relate to portable structures and combat and/or tactical training methods incorporating portable structures.

### BACKGROUND

Currently law enforcement, military and private sector security training is conducted at designated academies or bases nationwide. Historically, priority for training is given to basic training or new hires and as such these facilities are continually at capacity. The problem is there are an extra ordinate amount of law enforcement personnel, soldiers, and security that are not new hires. They are mandated by law, regulation or policy to attend refresher, in service and advanced training. If the existing facilities are at capacity for basic training, they have no facilities where they can adequately train and historically, refresher, in-service, or advanced training is left to make-do at best. Agencies then are left with few choices and a multitude of constraints consisting of availability and location, structure usability and functionality, leases and rental fees, undesirable locations and costly travel. Usually the agencies resign to renting or borrowing condemned or abandoned structures, improvising courses or facilities using plastic tape or cones, after hour use of community resources that effect overtime budgets and personnel families, static classrooms or even forgoing training altogether. Although there are a few private constructed training facilities in the United States, those facilities are space and usability limited based on availability, location, access and cost again leaving agencies still with no viable options for facilities to conduct needed training.

### SUMMARY OF THE DISCLOSURE

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concepts of the application, which is measured by the claims, nor is it intended to be limiting as to the scope of the inventive concepts in any way.

Phoenix's Portable Reality-Based Training Facility gives immediate freedom to agency personnel with the ability to conduct training away from the constraints of permanent structures. These multipurpose facilities provide that freedom by being portable, collapsible, reconfigurable, maneuverable and cost effective. The facilities can be utilized indoors as well as outdoors and will facilitate all types of law enforcement, military and private sector security training to include basic, refresher, in-service and advanced. With this facility agencies now have the ability to conduct training at their will, schedule, and budget. Agencies can now have a reality-based functional facility at any location such as in conference rooms, mat rooms, open fields, parking lots, firearm ranges, etc. These portable facilities allow static, dynamic and interactive training in instruction to include but not limited to tactics, control tactics, defensive tactics, use of force, close quarter battle, NLTA, firearms, cover courses, search and arrest warrants, briefings, interviews, role playing, scenarios and lectures, the combination of which are non-exclusively included in the definition of “tactical training”.

Embodiments of the present invention can be used in the Outfitter and Guide venues for sportsman's camps defining kitchens, sleeping areas, dining areas, and storage. Embodiments of the present invention can be used in disaster relief camps for temporary city configurations as well as configuring various types of living or business rooms. Embodiments of the present invention can be used as portable classrooms and training areas for other educational organizations as well as military or governmental agencies.

The present application discloses a method of tactical training for tactical activity and a portable structure for use with the method or in other occurrences. The method includes assembling a portable training structure that has at least one opening. This opening can be for ingress or for egress or it can operate similar to a window. For example, the opening can be used to simulate a casement or similar opening during tactical training. The structure does not have to be enclosed; the structure can have an open end or a similar structure as long as the structure can be used to simulate a structure found in an urban tactical situation. For example, a structure with an open end could be used to simulate an alleyway or similar occurrence found in a tactical situation, for example an alley. The structure is used to conduct tactical training simulations sessions using the portable structure to simulate a structure encountered in a tactical activity. These tactical activities can include, for example, law enforcement, military, S.W.A.T., or any other training that involves tactical maneuvering. After a training session is completed or a series of training sessions completed the structure is disassembled for portable transport. While the structure can be used to simulate urban buildings, the structure can also be used to simulate tactical situations found, for example, in caves, along hedgerows or groves of trees, or along freestanding walls. These examples are not meant to be limiting, but instead are exemplary in nature.

The structure can be assembled in a variety of ways. These methods include, but are not limited to, assembling a room frame, attaching frame structure parts to the room frame attaching wall materials to the frame structure to form walls of the portable training structure. The portable training structure can have a room on the inside of the structure to simulate, for example, individual rooms in buildings. The portable structure can be constructed by assembling an external frame followed by subdividing the internal space constructed by the outer frame into a plurality of internal rooms.

In a preferred embodiment the room structure frame has a series of wall supports and wall support connectors. When assembled together, the wall supports and wall support connectors generally form the frame of the portable structure. These wall supports and wall support connectors are connected together to form the portable structure frame. While the frame is being assembled or after assembly, a wall material can be added to the wall supports to form walls of the structure or the structure can be left without one or more walls, thus providing an open ended structure. Similarly, the wall material can be added to a frame component(s) of the portable structure before the frame components are connected to one another. The wall material can be added to the wall support connectors to form the walls of the structure or wall material can be added to both the wall supports and the wall support connectors to form walls of the structure. The wall material can be draped from wall supports on the top of the frame or can be attached to one or more of the horizontal supports or both.

The room support structure, in a preferred embodiment, is assembled by attaching a plurality of wall supports to a series of wall support connectors. In a preferred embodiment, one type of wall support used generally has a first end, a second end, and a length between the first end and the second end. In a preferred embodiment these wall supports are tubular and are configured to connect to the wall connectors. The supports are generally made of PVC, plastic, aluminum, or similar structural material. The first and second ends of the wall support are configured to connect to wall support connectors. There are generally two types of wall support connectors that are used in the preferred embodiment of the invention, although a wide variety of wall support connectors can be used. In a preferred embodiment, a corner connector of the wall support generally has a first axis and a second axis in a horizontal plane. The first axis and second axis intersect at a generally perpendicular angle with the wall support connector having a first end and a second end on each of the first axis and second axis. This forms generally an X shape. In a preferred embodiment, from generally the intersection of the two axes in the X shaped connector extending in a vertical direction is a third axis. While the connector is X-shaped in a preferred embodiment, it is not mandatory that the connector be made in an x-shape. This third axis has a first end that is attached to the X shape generally at the intersection of the first axis and second axis and proceeds at a generally perpendicular direction from the first axis and second axis. The corner connector is preferably configured to be a corner connector, although it can also be used as a side connector or end connector provided a wall support is not connected to either the first or second axis. A plurality of the wall support connectors and wall supports forming a corner are connected to form a general room of the structure. These wall supports can be made to be extendable or they can be made such that a second connector connects two wall supports to form a larger structure. The second connector generally is a wall support connector having a first end and a second end and defining a length between the first end and second end. In a preferred embodiment the second connector is used to connect two wall supports. However, the second connector can be use to connect a variety of wall supports and/or wall connectors to for the portable structure frame. This allows for flexibility in the length of the wall supports. The connector can have threaded ends in order to have wall supports attach to the wall support connector or can have any other known method of attachment.

Also disclosed is a portable structure in which the structure has a plurality of wall supports and a plurality of wall support connectors. In a preferred embodiment, at least one wall support connector defines a generally horizontal plane, the horizontal plane having a first axis and a second axis. The first axis and second axis are oriented in the generally horizontal plane. The first axis and second axis intersect in a generally perpendicular angle and defining a center point at which the first axis and second axis intersect. The first axis and the second axis each have a first end and second end and a length in between the first end and second end of each axis. The first axis and second axis intersect to form a generally x shaped connector, although the connector can occur in a variety of shapes depending on the need of the temporary structure constructor. In a preferred embodiment, the connector has a third axis which is generally perpendicular to the intersection of the first axis and the second axis although it can be orientated at a different location than at the exact center of intersection between the first axis and second axis. The wall supports in association with the wall support connectors are configured to be connected in order to form a room of the structure or the entire structure itself. The structure preferably has wall material that forms the walls of the structure. The structure can additionally have internal walls or can have additional walls attached to the structure in order to provide for a plurality of rooms. The wall material can be made of a variety of materials including, but not limited to, cloth, nylon, canvas, or any other type of material known in the art or developed in the future. While the word portable is considered in this application as meaning any structure that is portable, the application of portability is ideally thought to mean a structure that is easily assembled, packed, and loaded into a transportation vehicle for ease of transport. This step, in one embodiment, is able to occur with a minimum number of people in a minimum amount of time.

Still other features and advantages of the presently disclosed and claimed inventive concepts will become readily apparent to those skilled in this art from the following detailed description describing preferred embodiments of the inventive concepts, simply by way of illustration of the best mode contemplated by carrying out the inventive concepts. As will be realized, they are to be regarded as illustrative in nature, and not as restrictive in nature.

### BRIEF DESCRIPTION OF THE DRAWINGS

FIG. 1 is a perspective view of an embodiment of the invention of a portable structure that can be used for tactical training purposes.

FIG. 2 is a perspective view of an embodiment of a wall support of the portable training structure.

FIG. 3 is a perspective view of an embodiment of a wall support connector.

FIG. 4 is a perspective view of an embodiment of a wall support connector.

FIG. 5 is a perspective detail view of a corner of one embodiment of the invention of FIG. 1.

FIG. 6 is an exploded view of an embodiment of two wall support connectors connecting two wall supports in forming a portable structure.

FIG. 7 is an exploded schematic of a preferred embodiment of a wall support connector.

FIG. 8 is a perspective exploded view of an embodiment of a wall support connector.

FIG. 9 is a sectional view taken from FIG. 3 along line 9-9.

FIG. 10 is a sectional view taken from FIG. 4 along line 10-10.

FIG. 11 is a perspective view of an embodiment of the framework of the invention.

FIG. 12 is a stylized depiction of a storage/transport container for the dismantled parts of an embodiment of the invention.

### DETAILED DESCRIPTION OF THE EXEMPLARY EMBODIMENTS

While the presently disclosed inventive concepts are susceptible of various modifications and alternative constructions, certain illustrated embodiments thereof have been shown in the drawings and will be described below in detail. It should be understood, however, that there is no intention to limit the inventive concepts to the specific form disclosed, but, on the contrary, the presently disclosed and claimed inventive concepts is to cover all modifications, alternative constructions, and equivalents falling within the spirit and scope of the inventive concepts as defined in the claims.

In the following description and in the figures, like elements are identified with like reference numerals.

The use of “e.g.,” “etc,” and “or” indicates non-exclusive alternatives without limitation unless otherwise noted.

The use of “including” means “including, but not limited to,” unless otherwise noted.

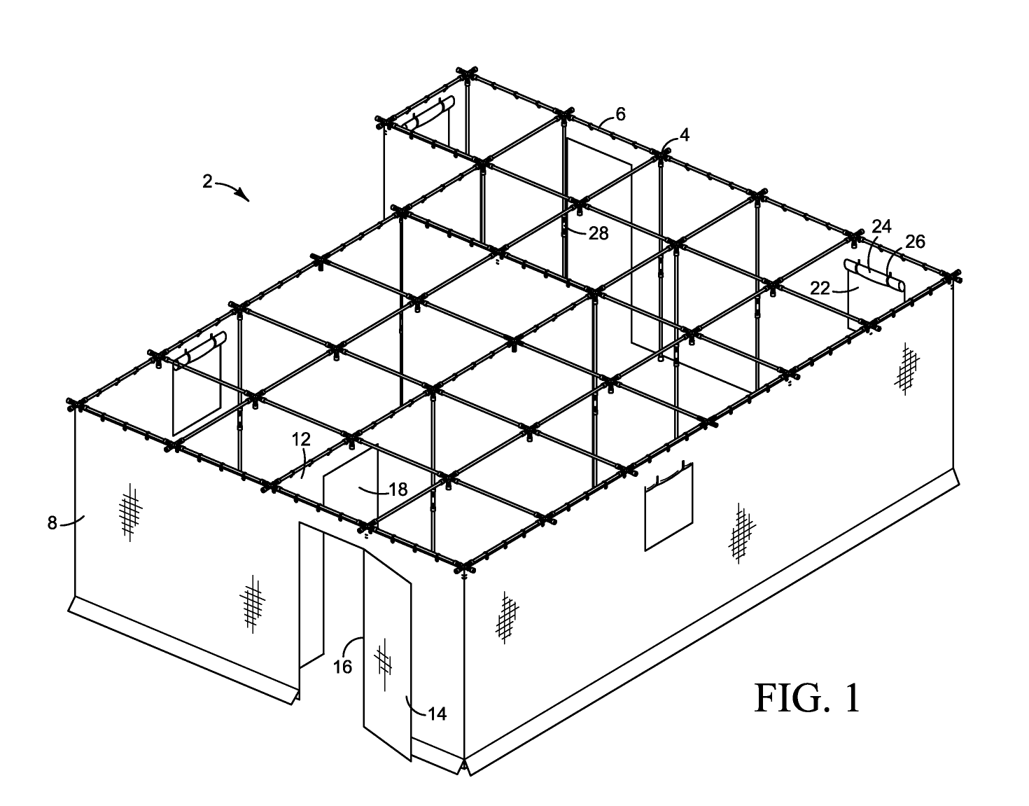

FIG. 1 represents a preferred embodiment of the current invention. FIG. 1 illustrates a portable structure 2 that is made of a frame having wall support connectors 4, wall supports 6, and wall materials 8, 12. The portable structure can be arranged to have individual rooms on the inside of the structure as depicted in FIG. 1. In the depicted embodiment, the individual rooms of the structure are divided using internal wall material 12 to make wall dividers between rooms. The portable structure can, for example, have openings 16, 18 for ingress and egress or can provide for a window or similar opening such as for simulating a casement. The portable structure can have doors 14 attached to the structure. These doors can be hinged 16 or they can be dropped down from the top such as illustrated by 24. In the illustration as depicted by number 24, there is a flap 26 that drops down over the opening 22 in order for the opening to be opened and closed. The flap 26 can be lifted up and attached to the structure to prevent it from closing over the opening. Alternatively it can be rolled or folded upward to prevent it from closing the opening. These openings can be arranged as windows or as doors and can be on the inside of individual rooms or on the exterior of the structure. A variety of materials can be used to function as walls or dividers for rooms.

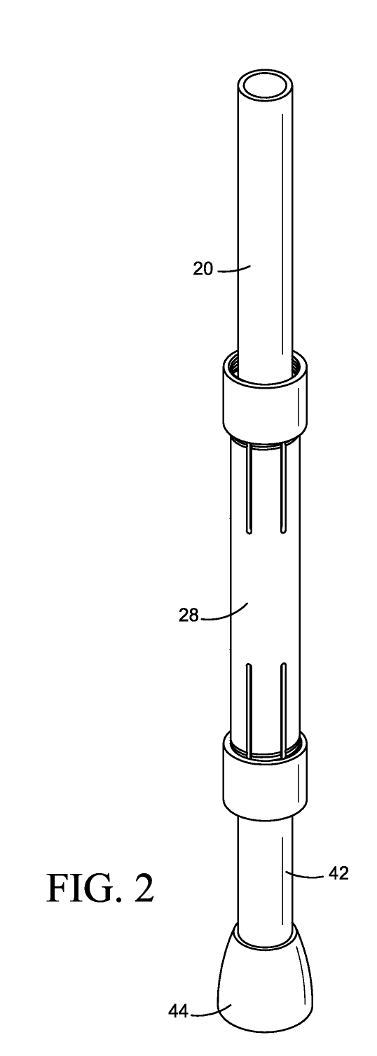

FIG. 2 illustrates a wall support of the current invention. The wall support can be made in a variety of shapes including the tubular shapes illustrated in FIG. 2. The wall support illustrated in FIG. 2 is designed to rest upon a floor. The wall support has a knob 44 that rests on the floor. This knob can be made out of rubber in order to prevent the peg from scratching the floor or to prevent the support from creating a hole in the floor. The wall support can have two parts 20, 42 that are connected by a wall support connector 28. Alternatively, the wall support can be one piece. The wall support can be made to be adjustable, i.e., a telescoping wall support or configured such that multiple wall supports can be attached to form an extended wall support.

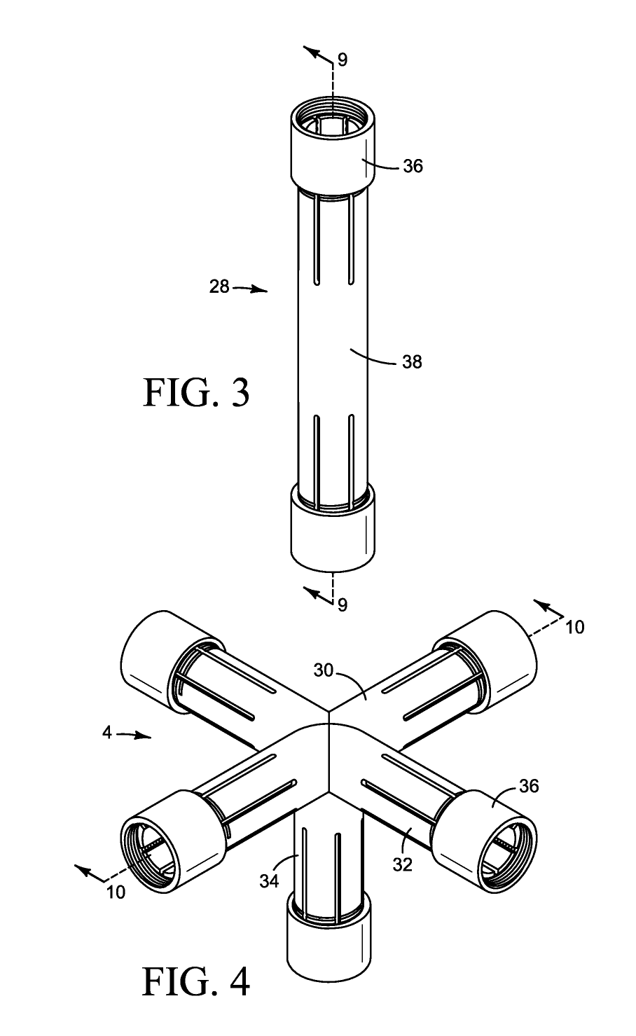

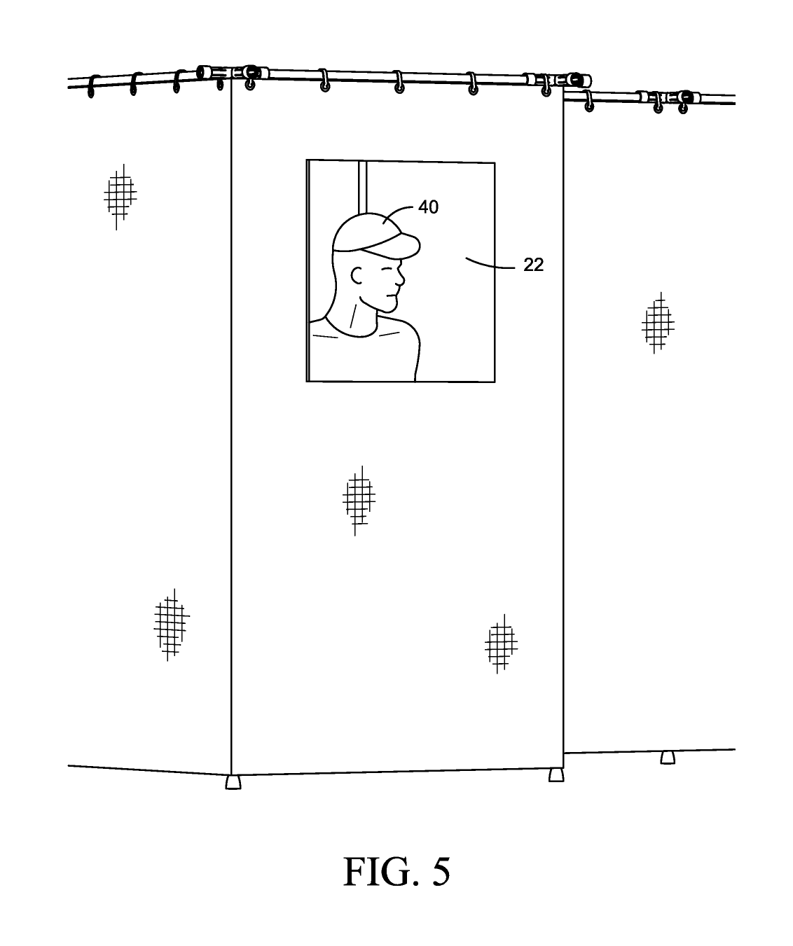

FIGS. 3 and 4 illustrate two embodiments of wall support connectors of the present invention. FIG. 3 illustrates a wall support connector that connects two wall supports to provide an extended wall support. This embodiment of the wall support connector has a threaded portion 36 that is used to connect the wall support connector to the wall supports. It has a length 38 in between a second wall support connector that as depicted is similar to the threaded portion 36. FIG. 3 illustrates that the threaded connector 36 threads onto a first wall support from a first side and to a second wall support on a second side. FIG. 4 illustrates a preferred embodiment of a corner connector. The corner connector has two axes as illustrated by 30 and 32. Wall supports can enter at the ends of each of these axes. The illustrated connector has a vertical axis 34 in which a floor connector can attach to the corner connector. FIG. 5 illustrates an embodiment of the invention in a training action. A FIG. 40 appears in the opening 22 as could occur in a military or tactical situation.

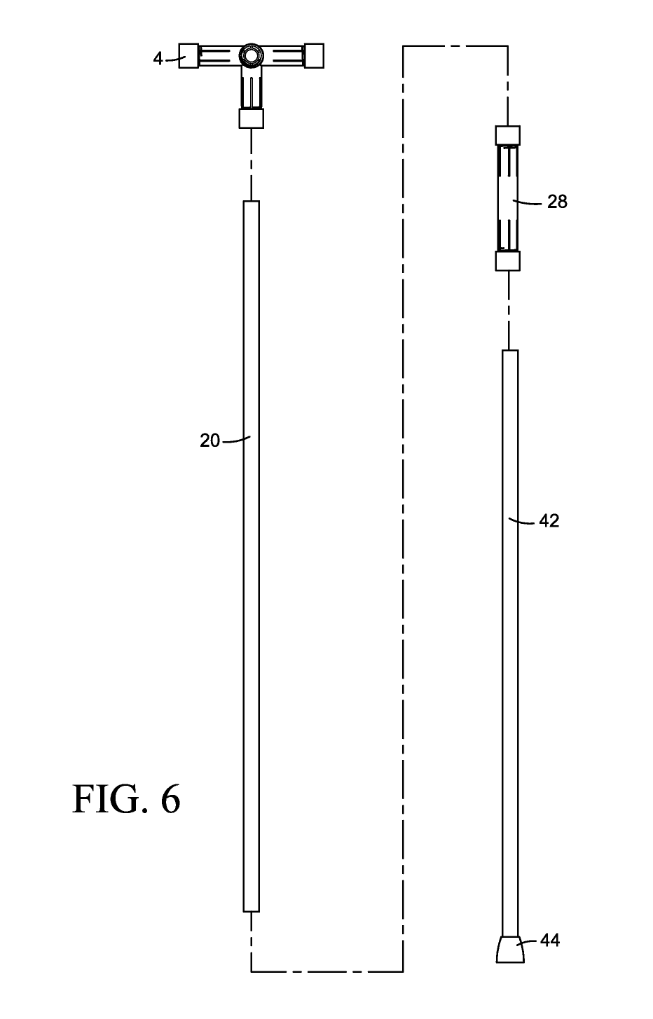

FIG. 6 represents two wall supports 20, 42 attached by connector 28 and illustrates how the wall support attaches to the corner connector 4. The depicted embodiment also has the knob at the end of support 42 for placement on the ground or floor. In a preferred embodiment, wall support 42 can be constructed with a knob 44 or similar mechanism for ensuring the wall support does not move after being positioned on a floor and/or to protect a floor the wall support is resting on.

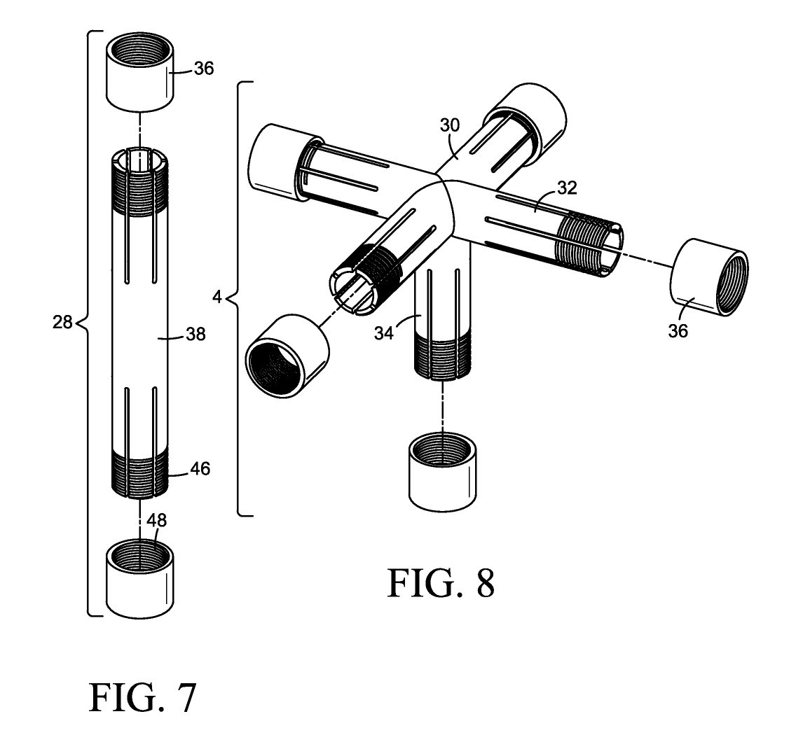

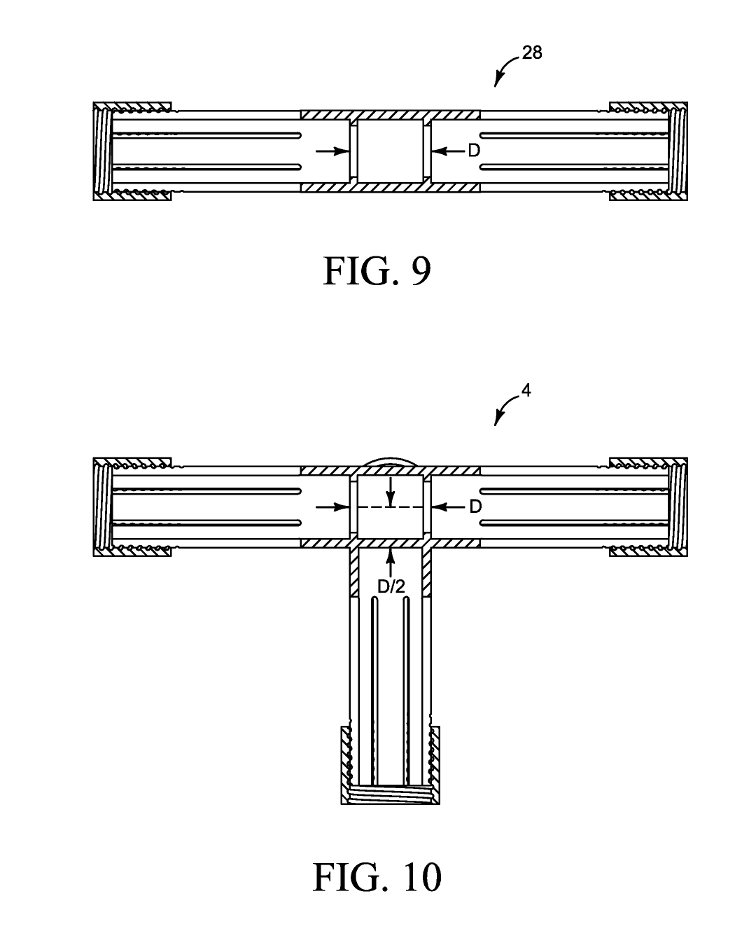

FIGS. 7 and 8 illustrate an embodiment of the invention in which threaded connectors 36 attach to a corner wall support connector and to a connector that functions to extend the length of the wall supports. The end corners 36, 48 thread to the end pieces of each of the connectors e.g., 46 and allow for the attachment of the wall supports via connecting the two parts via the threaded ends. While in a preferred embodiment, the threaded attachment is used, there are a wide variety of attachments that can be made such as snap together pieces, pin and hole attachments including a pawl type system, a clip in system, or a threaded system. FIGS. 9 and 10 depict the interior of two preferred embodiments of the connectors.

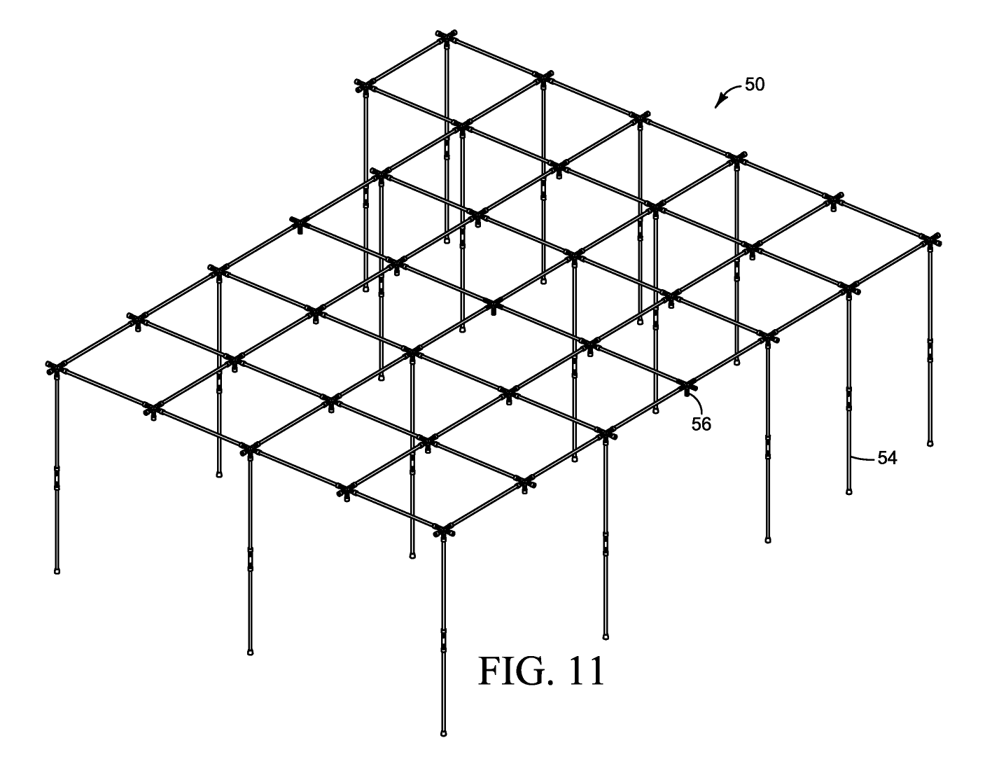

FIG. 11 illustrates the structural frame of the portable structure 50 without any wall material attached to the frame. While not depicted, the portable training structure can be utilized with roof or similar embodiment covering the top of the structure. As illustrated, the system can be set up in a preferred embodiment to have a multitude of rooms and wall material can be added to create additional rooms. Connectors 56 can be used with or without vertical wall supports and horizontal wall supports in each of the connector openings to alter the shape of the frame. As shown, the wall supports can be formed having a lower wall support 54 attached to the standard wall support via a connector, thus extending the height of the portable structure frame.

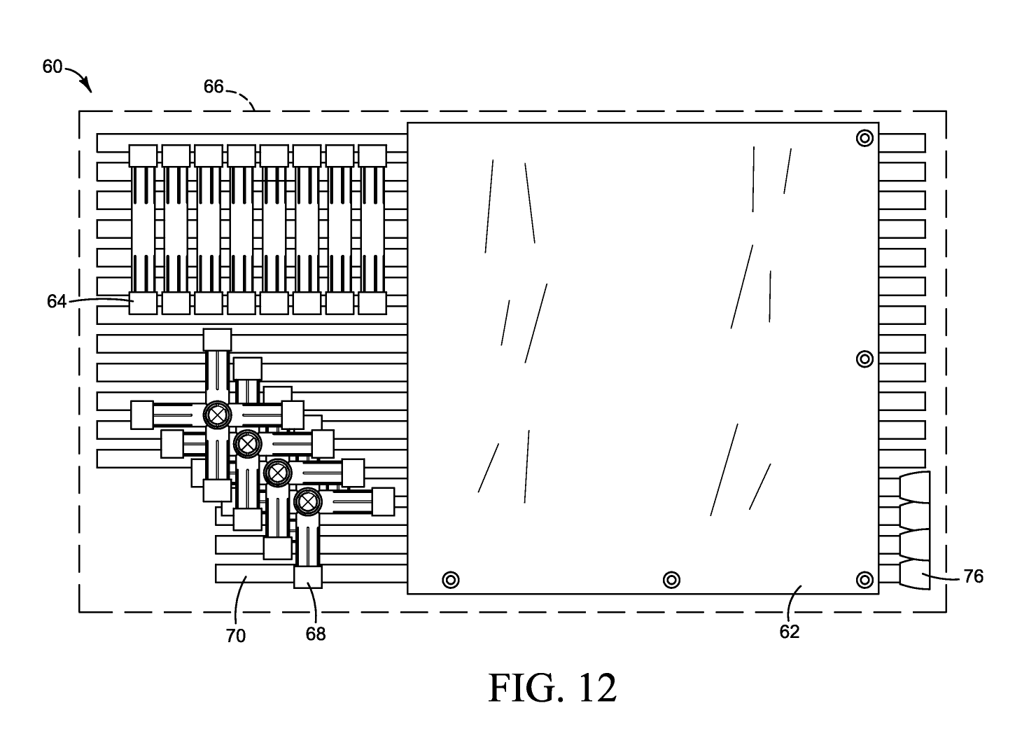

FIG. 12 illustrates the portability of an embodiment of the invention 60. The portable structure can be broken down and subsequently placed into one or more bags or bins 66 or compartments for storage and/or transport. In the depicted embodiment, wall supports 70 are placed in the bin 66 with bottom ground supports 76, wall supports 70, corner connectors 68, and straight wall support connectors 64. Wall material 62 is also included in the package.

1. A method of tactical training for a tactical activity, wherein said method comprises:
assembling a portable training structure,
conducting tactical training simulation sessions using said portable structure to simulate a structure encountered in a tactical activity,
disassembling said portable training structure.

2. The method of tactical training for a tactical activity of claim 1, wherein said step of assembling a portable training structure comprises the following steps:
assembling a room frame structure,
attaching frame structure parts to said first room frame structure to form a multiple room frame structure,
and attaching wall material to said frame structure parts to form walls of said portable training structure.

3. The method of tactical training for a tactical activity of claim 1, wherein assembling said portable training structure comprises the following steps:
providing a series of wall supports and wall support connectors,
connecting said wall supports and said wall support connectors to form a structure frame,
attaching wall material to a wall support to form a wall for said portable training structure.

4. The method of tactical training for a tactical activity of claim 3, wherein assembling said portable training structure comprises the following steps:
assembling a first room frame, wherein said first room frame defines a room space,
attaching a plurality of wall supports and wall support connectors to said first room frame to form a second room frame.

5. The method of tactical training for a tactical activity of claim 3, wherein assembling said portable training structure comprises the following step:
assembling a plurality of wall connectors and wall supports into a structure frame comprising a plurality of rooms

6. The method of tactical training of claim 5, wherein said wall material is attached to said wall supports and said wall connectors to form said structure walls.

7. The method of training of claim 1 wherein said persons being trained are selected from the group consisting of military persons and law enforcement persons.

8. The method of tactical training of claim 5, wherein said wall material is attached to said wall connectors to form said structure walls.

9. The method of tactical training of claim 1, wherein assembling said portable training structure comprises the following steps:
attaching a plurality of wall supports to a plurality of wall support connectors, wherein a wall support comprises a first end and a second end, wherein said wall support comprises a length between said first end and said second end, wherein said first end and said second end are configured to connect to a wall support connector,
wherein a wall support connector comprises a generally horizontal plane, wherein said connector comprises a first axis and a second axis in said horizontal plane, wherein said first axis and said second axis intersect at a generally perpendicular angle, wherein said wall support connector comprises a first end and a second end on said first axis and a first end and a second end on said second axis, wherein said first end and said second end of said first axis are located at opposite ends of said first axis, wherein said first end and said second end of said first axis are configured to connect to a wall support, wherein said first end and said second end of said second axis are located at opposite ends of said second axis, wherein said first end and said second end of said second axis are configured to connect to a wall support, wherein said wall support connector comprises a third axis, wherein said third axis intersects said first axis and said second axis generally at the intersection of said first axis and said second axis, wherein said third axis is generally perpendicular to said first axis and said second axis at the intersection of said first axis said second axis and said third axis, wherein said third axis comprises a first end and a second end, wherein said first end of said third axis is connected to said intersection of said first axis and said second axis and said third axis, wherein said second end of said third axis is configured to connect to a wall support,
wherein a corner of a wall section is formed by connecting a first end of a first wall support to said first end of said first axis of said wall support connector and by attaching a second wall support to said second end of said second axis and by attaching a third wall support to said first end of said third axis, wherein a portable structure comprising at least one room is assembled by connecting a plurality of wall support connectors and a plurality of wall supports to form a plurality of corners of said portable structure, wherein a plurality of interconnected corners forms a portable structure frame comprising portable structure frame components, attaching wall material to at least one portable structure frame component to form a wall of said portable structure.

10. The method of tactical training of claim 9, wherein connecting a plurality of corners forms a wall frame, wherein a room frame comprises eight wall support connectors and twelve wall supports arranged to form a plurality of corners, wherein a plurality of corners are arranged to form a room frame, wherein said room frame is configured to attach to a second room frame to form a multiple room frame structure, wherein said wall supports and said wall support connectors of said room frame are configured to form a first wall opening, a second wall opening, a third wall opening, a fourth wall opening, a ceiling opening, when arranged in a room frame, wherein said room frame is configured to attach to said wall material to form at least one wall, wherein said wall material is configured to cover a portion of at least one wall opening to form said wall, wherein said room frame is configured to attach to a second room frame to form a multiple room frame.

11. The method of claim one wherein said method comprises the step of placing said portable structure into at least one storage container after said portable structure is disassembled.

12. The method of claim 9 wherein said wall supports comprise an adjustable length, wherein said method comprises the step of adjusting the length of said wall supports.

13. The method of claim 12, wherein said wall supports comprise a telescoping adjustable length.

14. The method of claim 2 wherein said wall material comprises at least one material selected from the group consisting of nylon and canvas.

15. The method of claim wherein said wall supports comprise tubular supports.

16. The method of claim 16 wherein said tubular supports comprise a material selected from the group consisting of aluminum, plastic, and wood.

17. The method of claim 1 wherein said portable training structure comprises a plurality of rooms.

18. The method of claim 1 wherein said portable training structure is capable of being assembled into multiple different structure orientations.

19. The method of claim 1, wherein said portable training structure comprises at least one opening.

20. A portable structure, wherein said structure comprises:
a plurality of wall supports,
a plurality of wall support connectors, wherein at least one wall support connector generally defining a horizontal plane, wherein said horizontal plane comprises a first axis and a second axis, wherein said first axis and said second axis are generally oriented such that said first axis and said second axis are in said generally horizontal plane, wherein said first axis and said second axis intersect at a generally perpendicular angle and defining a center where said first axis and said second axis intersect, wherein said first axis and said second axis have a first end and a second end, wherein said first end and said second end are configured for connection to a wall support, wherein said wall support connector defines a vertical plane, wherein said vertical plane is generally perpendicular to said horizontal plane, wherein said vertical plane comprises a vertical axis, wherein said vertical axis comprises a first end connected generally at said center of said x shape and a second end configured to be connected to a wall support,
wherein said wall supports are configured to connect to said wall support connectors to form a frame of said portable structure,
wherein said wall supports are configured to support a wall material, wherein said wall material is configured to form walls for said portable structure, wherein said wall comprises at least one opening configured for ingress and egress.
